(19) United States
(12) Patent Application Publication
(10) Pub. No.: US 2004/0018264 A1
(43) Pub. Date: Jan. 29, 2004

(54) Device and a method for sectioning of tissue blocks

(76) Inventors: Graziano Cancian, Ans (DK); Carsten Reides Bjarkam, Risskov (DK); Jens Christian Hedemann Sorensen, Ega (DK); Ulrik Kjaergaard Sorensen, Bronshoj (DK)

Correspondence Address: CANTOR COLBURN, LLP, 55 GRIFFIN ROAD SOUTH, BLOOMFIELD, CT, 06002

(21) Appl. No.: 10/415,530

(22) PCT Filed: Oct. 17, 2001
(86) PCT No.: PCT/DK01/00687

(51) Int. Cl. G01N 1/06

(52) U.S. Cl. 425/117; 425/289; 425/295; 264/157

(57) ABSTRACT

The invention consists of a device and a method for sectioning of organs and irregular tissue blocks into tissue sections of a predefined thickness and orientation, in one uniform working process. The tissue is embedded into an alginate polymer, which is poured into an embedding container with two opposite arrays of parallel grooves. After hardening, the polymer can be sectioned in slices of a predetermined thickness. This is achieved by razor blade cuts through an array of parallel grooves in the embedding container. Finally, the tissue and alginate polymer can be removed by removing the side of the embedding container resulting in a series of parallel sections of predefined and often equal thickness.

The present invention relates to a device and a method for sectioning of tissue blocks.

The cutting of small organs, for example rodent brains, into sections of equal thickness and orientation can be performed by means of a metal container which has an internal profile resembling the organ in question. These known art metal containers also have a set of parallel grooves that can accommodate a razor blade. After a series of razor blade cuts by means of this technique, it is possible to obtain a series of parallel sections of equal thickness. The known art metal containers, however, have the disadvantages that the internal profile does not completely fit the organ or tissue in question and that removal of the sectioned organ or tissue is difficult. In order to solve these difficulties, the invention utilizes embedding of the organ or tissue in a cold polymerizate of alginate and water as described in international patent application No. WO 00/37918. The embedding technique protects the organ during the cutting procedure and reduces deformation of the organ to a minimum due to the accurate fit of the alginate polymer surrounding the organ.

From WO 00/37918, an apparatus for cutting embedded tissue into slices is also known. However, this apparatus and cutting technique may be inopportune due to a high friction coefficient of the razorblade array when cutting embedded tissue, and the time it takes to carry out the slicing process for small organs or small blocks of tissue, in particular.

For this reason, it is the object of the present invention to provide a device and a method for cutting which can be used for any organ or tissue, and which are quick in use for small organs or blocks of tissue in order to prepare a sample for comparative microscopical and digital image analysis and quantitative stereology.

This object is achieved by a device for sectioning a block of tissue into slices of a predetermined thickness and orientation, said device including means for forming an embedding chamber on a base member in such a way that a container for accommodating the block of tissue is formed by the embedding chamber means, the block of tissue may be moulded into an embedding alginate in said embedding chamber means, and means for precise slicing of the tissue block within this embedding chamber, said means including two opposite arrays of parallel grooves for receiving and guiding a cutting blade in the embedding chamber means.

In a first embodiment, the invention relates to a device for sectioning a block of tissue into slices of a predetermined thickness and orientation, said device including a tubular upper member for accommodating a block of tissue, where the upper member is telescopically mounted on a cylindrical base column on a base member in such a way that a container for accommodating the tissue is formed by the upper member in its upper position and the end of this cylindrical column, said upper member being provided with a number of parallel grooves for receiving and guiding a cutting blade.

Accordingly, the invention relates to a method of sectioning a block of tissue into slices of a predetermined thickness and orientation comprising the steps of selecting a top member with a series of parallel cutting grooves with appropriate interspacing, placing a block of tissue in the container formed by the upper member in its upper position and the base column, moulding a block of tissue or an entire organ into an embedding in said container, cutting the embedded tissue into sections, and retracting the upper member to remove the sections of tissue.

Hereby, a simple and quick-to-operate sectioning device is provided which is particularly useful for microscopical examinations of small blocks of tissue or organs. By a device according to the invention, the tissue block may be positioned in the embedding chamber in a predetermined orientation, so that the slices produced by the subsequent sectioning correspond to the sections of a microscopic and digital image analysis and quantitative stereology. By cutting the tissue block in the same chamber it is embedded in, a very precise sectioning may be obtained since the embedded tissue block is not removed from the moulding container and positioned in a corresponding position in a sectioning apparatus this provides a device which is simple and rapid in use and also provides precise sections of the tissue blocks.

The piston action of the base column of the cutting device provides a simple solution to removal of the organ and the embedding, i.e. alginate polymer, after the cutting. Likewise, the alginate detaches easily from the tissue slices. The apparatus meets the requirements of quantitative unbiased stereology (CV Howard and MG Reed Unbiased Stereology. Three-dimensional Measurement in Microscopy, BIOS Scientific Publishers, Oxford, 1998) and can also be used for preparation of tissue slices of fresh tissue or organs with regard to biochemical and physiological experimentation.

In the preferred embodiment, the upper member and the corresponding base column are cylindrical in shape. This shape is relatively inexpensive to produce and offers great accuracy and a sectioning device with this particular shape also allows the upper member to be rotated relative to the base column which makes the device easy to assemble and disassemble, e.g. when the sections are to be removed.

In a first embodiment, the parallel grooves of the upper member are provided with equal interspacing. Hereby, a predetermined, uniform thickness of the slices may be achieved.

In an alternative embodiment, the parallel grooves of the upper member are provided with different interspacing. If deemed appropriate, an upper member with such a series of parallel grooves may be used.

Preferably, the container, formed by the upper member in an advanced position and the end surface of the base column, is a moulding form for moulding a block of irregular tissue or entire organs into an embedding of alginate polymer or similar biologically inert material. This makes the device simple and quick to use, since both the moulding and the cutting actions may be performed on the block of tissue while it is positioned in the same container. Thus, no removal of the tissue embedding from a moulding apparatus to a cutting apparatus is necessary.

In the preferred embodiment, the parallel grooves are adapted to guide a handheld razor blade to be used in the cutting action. However, it is realised by the invention that other kinds and sizes of cutting blades may be used.

Preferably, the device is provided with locking means for holding the upper member in a predetermined position relative to the surface of the column. Hereby, the upper member may be secured to the base column in such a manner that the height of the container may be adapted to the particular block of tissue to be embedded and/or sectioned.

In a preferred embodiment of the locking means, the locking means comprises a locking mechanism including at least one spring-loaded ball arranged radially in the column which cooperates with a corresponding opening in the lower portion of the upper member. Hereby, a simple and reliable locking mechanism is provided. Advantageously, the lower end of the upper member rests on the locking mechanism when the upper member is in its advanced position.

As an alternative or a supplement to the first embodiment of the locking means, the locking means may also comprise at least one treated hole fitted with a corresponding locking screw in the upper member. Hereby, the upper member may be secured to the column at any given position.

Advantageously, the upper member may be retracted to a position below the end surface of the base column. This makes it particularly simple to remove the slices and the alginate embedding material.

A second embodiment of the invention relates to a device for sectioning of a block of tissue into slices with a predetermined thickness and orientation, said device including: two parallel arrays of rods with equal interspacing placed orthogonally into a base plate, each array of rods having a first and second corner rod, and a first and second side members being retractably positioned between two oppositely disposed corner rods in each of the arrays of rods, in such a way that a container for accommodating tissue is formed.

In this embodiment, the device is simple to manufacture and required a small amount of material. Moreover, by providing the arrays of grooves by two arrays of rods it is a simple measure to alter the slicing thickness simply by replacing the rods by sets of rods with different dimensions, e.g. diameters, whereby the gap between the rods is altered accordingly.

Preferably, the side members are interlocking plates. Hereby, the side members are secured and retained in a position relative to the arrays of rods in a precise and simple manner.

Preferably, the rods are placed orthogonally in the base plate in a semi-circular, curved or angled shape and the interlocking plates also are semi-circular curved or angled. By providing interlocking plates and or a base plate with receiving means for the rods in different shapes, different sizes and shapes may be provided for corresponding the actual application of the sectioning device. In an alternative embodiment, the rods are placed in the base plate at an inclined angle that is different from 90 degrees.

In an embodiment, an extra set of plates are placed in parallel with the array of rods, hereby, the moulding material may be obtained within the embedding container during the moulding process. The extra plates may be removed when the embedding material is cured and the cutting process is about to be started.

As described above, the diameter of the rods in the arrays of rods may be selected in accordance with the desired interspacing of the gaps between the rods in the array in order to achieve the desired thickness of the tissue slices. In another embodiment, the array of rods are replaced by a plate with cut parallel grooves with equal or different interspacing. Hereby, the sectioning device according to the invention may be configured in accordance with an actual scanning for a reliable comparative study of the tissue block.

In order to facilitate the cutting operation, in particular by small thickness slices, the array of rods or cut lamellae preferably have alternating different height in order to facilitate the cutting process.

The invention will be described in detail below with reference to the accompanying drawings, in which

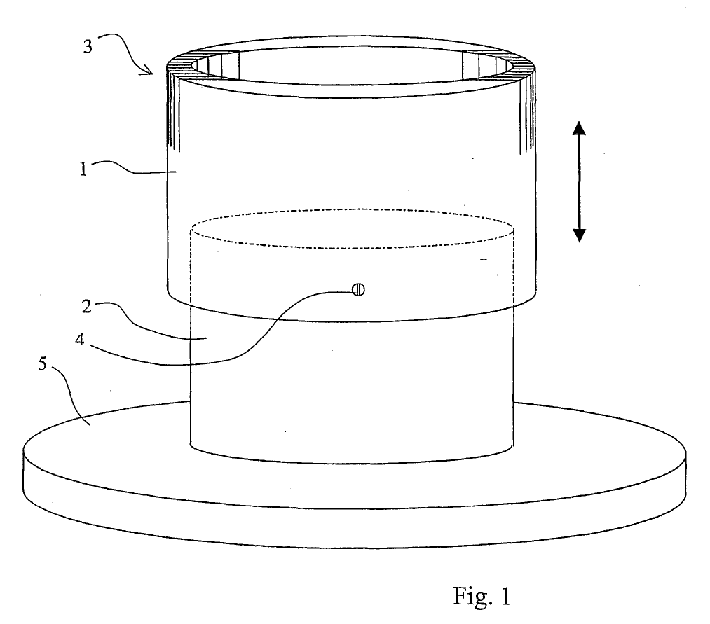

FIG. 1 is a perspective view of the sectioning device according to the invention,

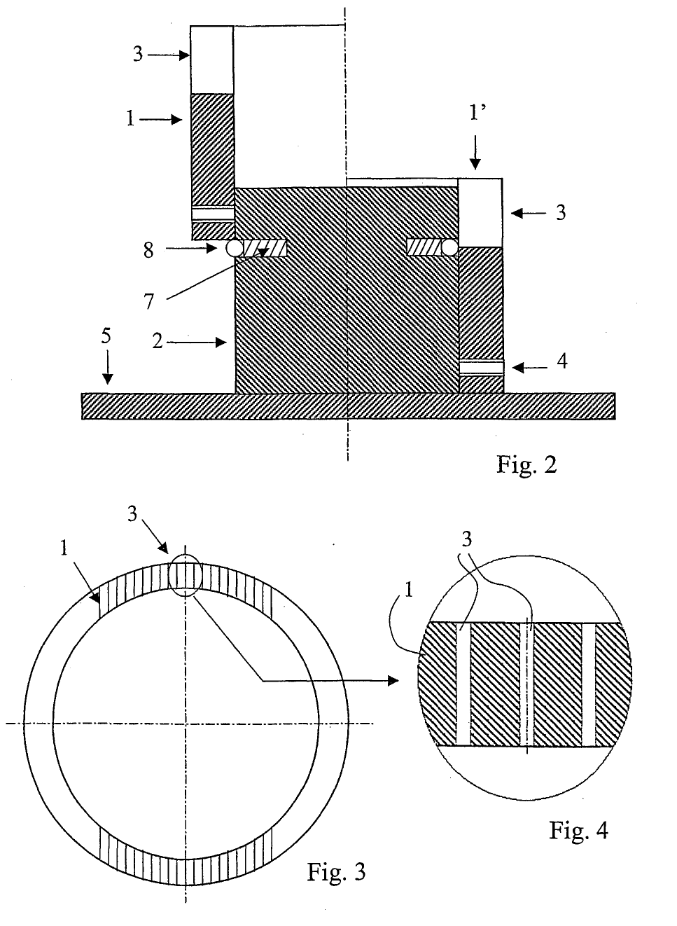

FIG. 2 is a cross-section view of the device in its advanced and retracted positions,

FIG. 3 is a schematic top view,

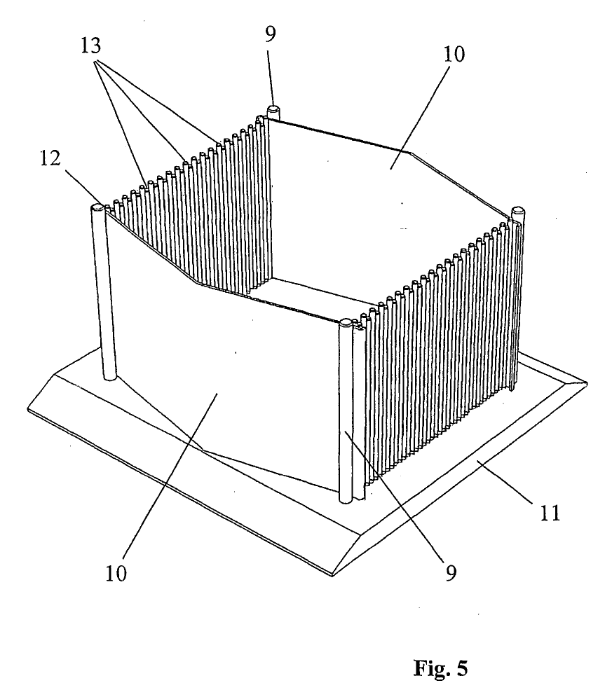

FIG. 4 is a detailed view thereof, and

FIG. 5 shows a perspective view of the end of the sectioning device with the rods and interlocking plates.

In the figures, a preferred embodiment of the invention is shown. The sectioning device comprises a tubular upper member 1 that fits over a bottom column 2 on a base-plate 5. The top tube 1 is fitted with a number of parallel groves 3 with predefined interspacing, either equal or different interspacing. When the top tube 1 is in place on the bottom column 2, the two form a container that can be filled with alginate polymer for organ embedding (not shown in the figures). When the still wet alginate and water mould is poured into the container, the tissue or organ block can be placed in the mould. The alginate mould is now left for 2 to 5 minutes to polymerize. After polymerization, the leading of a razor blade (not shown) down through each of the parallel groves 3 can cut the tissue and alginate block. After the cutting, the top tube 1 can be slid down along the bottom column 2 leaving the sectioned tissue and alginate block on the end surface on top of the bottom column 2.

The device is fitted with an internal ball lock mechanism 7, 8 which will lock the top tube 1 in place on top of the bottom column 2 by turning for as long as the tissue embedding and sectioning is going on. In the preferred embodiment of the invention, the top tube 1 and the bottom column 2 are concentric cylinders. This embodiment allows the top tube 1 to be turned around the bottom column 2. The turning action is performed by the ball lock mechanism 7, 8 to further secure the top tube 1 in place on the bottom column 2.

The locking mechanism includes a hole in the base column 2 in which a spring 7 is provided. A ball 8 with a similar diameter to that of the hole is positioned at the outer end of the spring, so that a spring-loaded ball locking mechanism is provided. As shown in the left-hand side of FIG. 2, the upper member 1 may rest on top of the ball 8 in the extended, upper position. On the right-hand side of FIG. 2, the upper member 1′ is shown in the retracted position.

As an alternative or a supplement, the upper member 1 may be provided with a treated hole 4 in the wall of the lower part. In this hole 4, a screw may be provided so that the upper member 1 may be fastened to the column 2 by fastening the screw.

Alternatively, the bottom column may be fitted with a groove which prevents rotation of the cylindrical block of embedding material during the cutting process.

In an alternative embodiment the sectioning device is comprised of a base plate 11 with steel rods 13 inserted into corresponding tightly fitting holes, see FIG. 5. The steel rods 13 can be cylindrical, ovoid or polygonal. The steel rods 13 are placed as two separate arrays at a predetermined distance free of choice. Each array of rods 13 is provided with corner rods 9 at their extreme ends. The two arrays are parallel and positioned opposite each other and the steel rods 13 are placed orthogonally with regard to the base plate 11. Each of the two arrays of steel rods 13 can be closed by two side members, preferably a steel plate 10. Each of the side members 10 are placed between two opposite corner rods 9 and fits tightly between the corner rod 9 and its neighboring rod, thus formiing a square or a rectangular embedding and sectioning chamber.

In an alternative embodiment the rods can be placed in a semi-circle or semi-ovoid and the interlocking plates 10 can likewise be semi-circular or semi-ovoid resulting in a circular or an ovoid embedding and sectioning chamber.

The two plates 10 and the four corner rods 9 can be removed in order to gain access to the embedding chamber.

The embedding medium, an alginate mould in the preferred embodiment, can now be poured into the embedding chamber. An extra set of plates (not shown) can alternatively be placed on the outside of the embedding chamber and in parallel with the array of rods 13. This can be if the embedding medium has low viscosity, thus preventing leakage through the inter space or grooves 12 between the individual rods 13. Before the polymerization of the embedding medium, a tissue piece or an organ can be placed and oriented in the alginate mould. After the alginate mould has hardened the alternative embodiment of the sectioning machine will now allow a knife blade to cut through alginate and tissue between each of the parallel steel columns, thus producing of series of parallel sections of the alginate and the embedded tissue piece or organ. The rods can have alternating different heights as shown in FIG. 5 in order to facilitate the placing of the razor blade or knife at the initiation of the cutting process. After the sectioning process one or both steel plates can be removed and the alginate and tissue slabs can be removed from the embedding chamber sideways in parallel with base plate.

With the side member plates placed in the cutting device as shown in FIG. 5, a fresh alginate mould is poured into the embedding chamber. A piece of tissue is placed and oriented in the still soft mould. After the alginate has polymerized a knife or razor blade can now be lead down to each of the parallel inter spaces between the steel rods 13. This results in a series of parallel slabs of alginate and tissue. After the cutting procedure the side plates of the cutting box can be removed and the sectioned tissue and alginate can now be moved sidewise in parallel with the base plate, out of the cutting device in an easy manner. To facilitate this removal two cuts through the embedding medium can be made adjacent to, and in parallel with the array of rods.

The invention consists of a device and a method for sectioning of organs and irregular tissue blocks into tissue sections of a predefined thickness and orientation, in one uniform working process. The tissue is embedded into an alginate polymer, which is poured into an embedding container with two opposite arrays of parallel grooves. After hardening, the polymer and the embedded tissue block can be sectioned in slices of a predetermined thickness. This is achieved by razor blade cuts through an array of parallel grooves in the embedding container. Finally, the tissue and alginate polymer can be removed by removing the side of the embedding container resulting in a series of parallel sections of predefined and often equal thickness.

1. A device for sectioning a block of tissue into slices of a predetermined thickness and orientation, said device including
means for forming an embedding chamber on a base member in such a way that a container for accommodating the block of tissue is formed by the embedding chamber means,
the block of tissue may be moulded into an embedding alginate in said embedding chamber means, and
means for precise slicing of the tissue block within this embedding chamber, said means including two opposite arrays of parallel grooves for receiving and guiding a cutting blade in the embedding chamber means.

2. A device for sectioning a block of tissue into slices of a predetermined thickness and orientation, said device including an embedding chamber means, said embedding chamber means being a tubular upper member for accommodating a block of tissue, where the cylindrical upper member is telescopically mounted on a cylindrical base column on a base member in such a way that a container for accommodating the tissue is formed by the upper member in its upper position and the end of this cylindrical column, said upper member being provided with a number of parallel grooves for receiving and guiding a cutting blade.

3. A sectioning device according to claim 1 or 2, wherein the upper member and the corresponding base column are ovoid or polygonal in shape.

4. A sectioning device according to claim 2 or 3, wherein the parallel grooves of the upper member are provided with equal interspacing.

5. A sectioning device according to claim 2 or 3, wherein the parallel grooves of the upper member are provided with different interspacing.

6. A sectioning device according to any of claims 1 to 5, wherein the container, formed by the upper member in an advanced position and the end surface of the base column, is a moulding form for moulding a block of irregular tissue or entire organs into an embedding of alginate polymer or similar biologically inert material.

7. A sectioning device according to claim 1 or 2, wherein the parallel grooves are adapted to guide a handheld razor blade to be used in the cutting action.

8. A sectioning device according to any of the preceding claims, wherein the device is provided with locking means for holding the upper member in a predetermined position relative to the surface of the column.

9. A sectioning device according to claim 8, wherein the locking means comprises a locking mechanism including at least one spring-loaded ball arranged radially in the column which cooperates with a corresponding opening in the lower portion of the upper member.

10. A sectioning device according to claim 9, wherein the lower end of the upper member rests on the locking mechanism when the upper member is in its advanced position.

11. A sectioning device according to any of claims 8 to 10, wherein the locking means comprises at least one treated hole fitted with a corresponding locking screw in the upper member.

12. A sectioning device according to any of the preceding claims, wherein the upper member may be retracted to a position below the end surface of the base column.

13. A device for sectioning of a block of tissue into slices with a predetermined thickness and orientation, said device including:
two parallel arrays of rods with equal interspacing placed orthogonally into a base plate, each array of rods having a first and second corner rod, and
a first and second side members being retractably positioned between two oppositely disposed corner rods in each of the arrays of rods, in such a way that a container for accommodating tissue is formed.

14. A sectioning device according to claim 13, wherein the side members are interlocking plates.

15. A sectioning device as in claim 14, wherein the rods are placed orthogonally in the base plate in a semi-circular, curved or angled fashion and the interlocking plates also are semi-circular curved or angled.

16. A sectioning device as in claim 13, wherein the rods are placed in the base plate at an inclined angle that is different from 90 degrees.

17. A sectioning device as in claim 14, wherein an extra set of plates are placed in parallel with the array of rods.

18. A device according to claim 13, wherein the diameter of the rods in the arrays of rods may be selected in accordance with the desired interspacing of the gaps between the rods in the array in order to achieve the desired thickness of the tissue slices.

19. A device as in any of claims 13-17, wherein the array of rods are replaced by a plate with cut parallel grooves with equal or different interspacing.

20. A device as in any of claims 1, 2, 13 or 19, wherein the array of rods or cut lamellae have alternating different height in order to facilitate the cutting process.

21. A method of sectioning a block of tissue into slices of a predetermined thickness and orientation comprising the steps of selecting a top member with a series of
parallel cutting grooves with appropriate interspacing,
placing a block of tissue in the container formed by the upper member in its upper position and the base column,
using a polymer mould for embedding of a block of tissue or an entire organ in said container,
cutting the embedded tissue into slices, and
retracting the upper member to remove the sections of tissue.

22. A method of sectioning a block of tissue into slices of a predetermined thickness and orientation comprising the steps of
placing a block of tissue in a container made up by an embedding chamber formed by two oppositely disposed arrays of rods or plates with cut grooves and two oppositely interlocking side members therebetween,
using a polymer mould for embedding of a block of tissue or an entire organ in said container,
cutting the embedded tissue into slices of equal or variable thickness by using two opposite gaps of the parallelly disposed gaps between the rods in the arrays of rods, and
removing the side members to remove the sections of tissue.
